(19) United States
(12) Patent Application Publication
(10) Pub. No.: US 2007/0182685 A1
(43) Pub. Date: Aug. 9, 2007

(54) Display device

(75) Inventors: Jae-hyoung Park, Yongin-si (KR); Haeng-won Park, Seongnam-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/701,664

(22) Filed: Feb. 1, 2007

(30) Foreign Application Priority Data
Feb. 3, 2006 (KR) 10-2006-0010696

(51) Int. Cl. G09G 3/36

(52) U.S. Cl. 345/96

(57) ABSTRACT

A display device with less horizontal crosstalk includes an array of pixel electrodes connected to and driven by a plurality of switching devices, the plurality of pixel electrodes arranged in a matrix, a plurality of gate lines which extend in a row-wise direction and are located between each of the plurality of rows of the pixel electrode array and at both sides of the pixel electrode array, and a plurality of data lines which extend in a column-wise direction and are located between each of the plurality of columns, wherein switching devices of horizontally neighboring pixel electrodes belonging to a given row among the plurality of rows of the pixel electrode array are controlled by gate lines belonging to different rows that are adjacent to the neighboring pixel electrodes.

This application claims priority from Korean Patent Application No. 10-2006-0010696 filed on Feb. 3, 2006 in the Korean Intellectual Property Office, the disclosure of which is incorporated herein by reference.

### FIELD OF THE INVENTION

The present invention relates to a display device, and more particularly to a display device with less horizontal crosstalk.

### DESCRIPTION OF THE RELATED ART

Flat panel display devices such as the liquid crystal display (LCD), the electroluminescent display (ELD), the plasma display panel (PDP), and so on, generally include a plurality of gate lines and a plurality of data lines which are insulated from the gate lines and cross over the gate lines, and a driving unit for driving the display panel. Switching devices drive the pixel electrodes that are located at the intersections between the gate lines and the data lines. When the switching devices are turned on or off, the pixel electrodes are charged with data voltages from the data lines. The display panel also includes a common electrode to which a common voltage is applied and which, together with the pixel electrodes, generate electric fields. The difference between the data voltage and the common voltage corresponds to the pixel voltage.

While the common voltage applied to the common electrode remains constant, the data voltages may be affected by horizontal crosstalk. In addition, when data voltages applied to neighboring gate lines change in the same direction, that is, when the data voltages all increase or all decrease in the same direction, variations of the data voltages accumulate, and the horizontal crosstalk phenomenon may be aggravated.

The display device driving unit includes a gate driver and a data driver. The data driver is typically implemented by data driver integrated circuits (ICs). Since the polarity of the data voltages from each of the data driver ICs is generally fixed, there is a limit to applying data voltages having a desired polarity pattern to the data lines.

### SUMMARY OF THE INVENTION

The present invention provides a display device with less horizontal crosstalk which includes a matrix array of pixel electrodes driven by switching devices, a plurality of gate lines which extend in a row-wise direction between and at both sides of the pixel electrode array, and a plurality of data lines which extend in a column-wise direction and are located between each of the plurality of columns, wherein the switching devices of horizontally neighboring pixel electrodes are controlled by gate lines belonging to different rows. Therefore, even though data voltages applied to the data lines during the same time period are different from one another in terms of polarity, the switching devices connected to horizontally neighboring pixel electrodes belonging to a given row are connected to gate lines belonging to different rows adjacent to the pixel electrodes so that the data voltages applied to the pixel electrodes of the corresponding row will eventually have the same polarity.

### BRIEF DESCRIPTION OF THE DRAWING

The above and other features and advantages of the present invention will become apparent from a reading of the ensuing description together with the drawing, in which:

FIG. 1 is a block diagram of a display device according to an exemplary embodiment of the present invention;

FIG. 2 is a layout view of a display device according to a first embodiment of the present invention;

FIG. 3 is a cross-sectional view of the display device taken along the line III-III′ of FIG. 2;

FIG. 4 is a circuit diagram of the display device shown in FIG. 2;

FIG. 5 is a schematic plan view of the display device shown in FIG. 2;

FIG. 6 is a layout view of a display device according to a second embodiment of the present invention;

FIG. 7 is a circuit diagram of the display device shown in FIG. 6;

FIG. 8 is a schematic plan view of the display device shown in FIG. 6;

FIG. 9 is a waveform diagram of data voltages applied to data lines shown in FIG. 8;

FIG. 10 is a schematic plan view of the display device shown in FIG. 6, in which a first display pattern is implemented by the display device according to the second embodiment of the present invention;

FIG. 11 is a waveform diagram of data voltages applied to data lines shown in FIG. 10;

FIG. 12 is a schematic plan view of the display device shown in FIG. 6, in which a second display pattern is implemented by the display device according to the second embodiment of the present invention;

FIG. 13 is a waveform diagram of data voltages applied to the data lines shown in FIG. 12;

FIG. 14 is a schematic plan view of the display device shown in FIG. 6, in which a third display pattern is implemented by the display device according to the second embodiment of the present invention;

FIG. 15 is a waveform diagram of data voltages applied to data lines shown in FIG. 14;

FIG. 16 is a schematic plan view of the display device shown in FIG. 6, in which a fourth display pattern is implemented by the display device according to the second embodiment of the present invention;

FIG. 17 is a waveform diagram of data voltages applied to data lines shown in FIG. 16;

FIG. 18 is a circuit diagram of a display device according to a third embodiment of the present invention;

FIG. 19 is a plan view of the display device shown in FIG. 18;

FIG. 20 is a waveform diagram of data voltages applied to data lines shown in FIG. 19;

FIG. 21 is a plan view of the display device shown in FIG. 18, in which a first display pattern is implemented by the display device according to the third embodiment of the present invention;

FIG. 22 is a waveform diagram of data voltages applied to data lines shown in FIG. 21;

FIG. 23 is a plan view of the display device shown in FIG. 18, in which a second display pattern is implemented by the display device according to the third embodiment of the present invention;

FIG. 24 is a waveform diagram of data voltages applied to the data lines shown in FIG. 23;

FIG. 25 is a plan view of the display device shown in FIG. 18, in which a third display pattern is implemented by the display device according to the third embodiment of the present invention;

FIG. 26 is a waveform diagram of data voltages applied to the data lines shown in FIG. 25;

FIG. 27 is a plan view of the display device shown in FIG. 18, in which a fourth display pattern is implemented by the display device according to the third embodiment of the present invention; and

FIG. 28 is a waveform diagram of data voltages applied to the data lines shown in FIG. 27.

### DETAILED DESCRIPTION

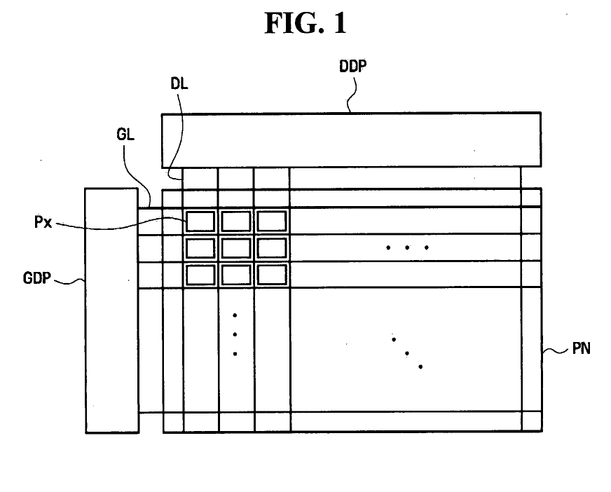

Referring to FIG. 1, the display device includes a display panel PN and a driving unit. The display panel PN includes a plurality of pixel electrodes Px arranged in a matrix array. A plurality of gate lines GL that extend in a row-wise direction of the pixel electrode array and are arranged among the rows of pixel electrodes Px. A plurality of data lines DL extend in a column-wise direction of the pixel electrode array and are arranged among a plurality of columns of pixel electrodes Px.

Gate lines GL are insulated from and cross over data lines DL. A plurality of switching devices (not shown) are respectively located at the intersections of gate lines GL and data lines DL. The switching devices may be thin film transistors (TFTs) that apply a data voltage from the data lines DL to the pixel electrodes Px. A gate signal applied to gate lines GL controls the turning on/off operation of the switching devices.

The driving unit includes a gate driving unit GDP and a data driving unit DDP. The gate driving unit GDP provides a gate-on signal and a gate-off signal to gate lines GL. The gate driving unit GDP may include a plurality of gate driver integrated circuits ICs (not shown). Each of the gate driver ICs may be mounted on a tape carrier package (TCP).

The driving unit may also include a control unit (not shown) which controls the gate driving unit GDP and the data driving unit DDP. The control unit may include a timing controller (not shown) which controls the timing of input signals.

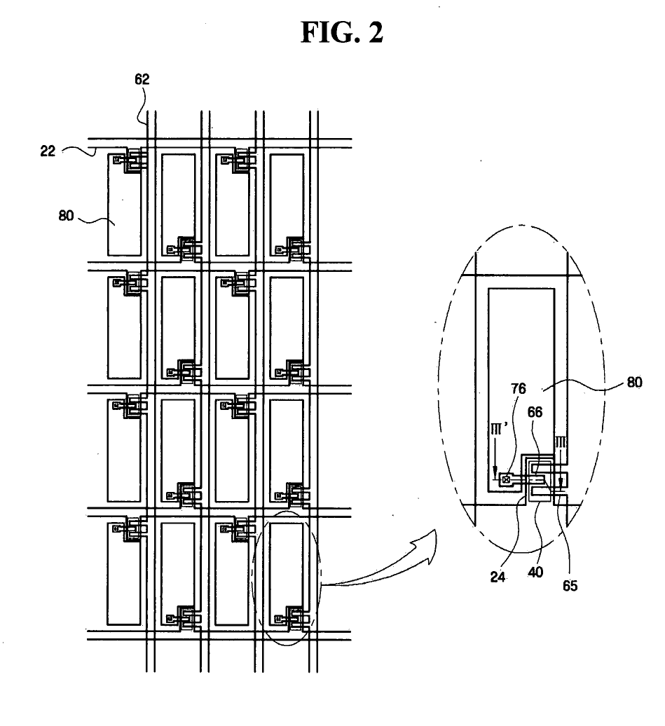

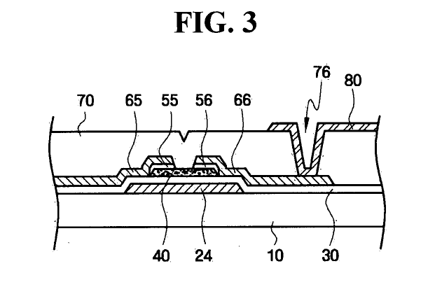

Referring to FIGS. 2 and 3, a plurality of pixel electrodes 80 are insulated from one another, and are arranged in a matrix. Each of a plurality of pixels is defined by neighboring gate lines 22 and neighboring data lines 62 and is almost completely covered by a pixel electrode 80. The plurality of pixels have substantially the same construction with one another are arranged in positions which are symmetrical to a specified line or point (line symmetry or point symmetry).

The construction of each pixel will now be described in detail with reference to FIGS. 2 and 3. Referring to FIGS. 2 and 3, a gate line 22 and a gate electrode 24 which extends from gate line 22 are formed on an insulating substrate 10. Gate line 22 and gate electrode 24 are covered by a gate insulation layer 30. A semiconductor layer 40 is formed on gate insulation layer 30 and at least partially overlaps gate electrode 24. A data line 62, a source electrode 65 which extends from the data line 62, and a drain electrode 66 which extends from the data line 62 and is separate from source electrode 65, are formed on semiconductor layer 40.

Ohmic contact layers 55 and 56 are interposed between source electrode 65 and drain electrode 66 where they overlap semiconductor layer 40. At a non-overlapping area, that is, an area where the ohmic contact layers 55 and 56 are not interposed between source electrode 65 and drain electrode 66 and semiconductor layer 40, source electrode 65, drain electrode 66, and data line 62 may be formed directly on the gate insulation layer 30.

The aforementioned structure is covered with a passivation layer 70. A pixel electrode 80 is formed on passivation layer 70 and is electrically connected to drain electrode 66 through a contact hole 76 formed through the passivation layer 70.

Although not shown, according to an embodiment of the present invention, the display device may also include a counter substrate which faces and is formed a predetermined distance apart from the insulating substrate 10. A medium layer may be interposed between the insulating substrate 10 and the counter substrate. The medium layer may be a liquid crystal layer containing liquid crystal molecules.

According to an embodiment of the present invention, the display device may include a common electrode. The common electrode generates an electric field in pixel regions together with pixel electrodes, thereby adjusting gray levels of each pixel. In other words, the display device may represent colors having different gray levels based on the electric field formed in each pixel. The common electrode may be formed on the insulating substrate 10 or the counter substrate which faces the insulating substrate 10.

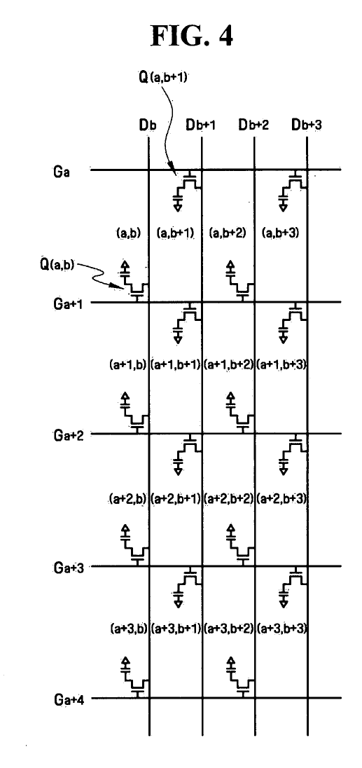

FIG. 4 is a circuit diagram of the display device shown in FIG. 2. Referring to FIG. 4, parenthesized pairs of reference characters such as (a, b) indicate matrix coordinates in a pixel electrode array.

Referring to FIGS. 2 and 4, a gate electrode 24, a source electrode 65, a drain electrode 66, and a semiconductor layer 40 constitute a switching device connected to a pixel electrode 80, e.g., a thin film transistor (TFT) Q. Gate electrode 24 is connected to an input terminal of TFT Q and thus controls the turning on/off operation of the TFT Q. When TFT Q is turned on in response to a gate-on signal applied through gate electrode 24, a channel is formed in semiconductor layer 40, so that a data voltage applied from a plurality of data lines D_{b}−D_{b+3} to the source electrode 65 is provided to drain electrode 66. The data voltage provided to drain electrode 66 is applied to pixel electrode 80 via a contact hole 76. FIG. 4 illustrates an exemplary capacitor constituted by pixel electrode 80 and a common electrode (not shown), in which a common voltage is applied to the common electrode, and the strength of the electric field held by the capacitor is determined by the difference between the data voltage applied to pixel electrode 80 and the common voltage.

TFTs Q connected to horizontally neighboring pixel electrodes 80 belonging to a given row are connected to gate electrodes 24 protruding from gate lines 22 belonging to different rows adjacent to the neighboring pixel electrodes 80. For example, as shown in FIG. 4, TFT Q_{(a,b)} of the pixel electrode located at an area defined by an (a)th pixel row and a (b)th column is connected to neighboring gate line Gₐ₊₁ located directly above the (a+1)th pixel row. Similarly, the TFT Q_{(a,b+1)} of a pixel electrode located at an area defined by the (a)th pixel row and a (b+1)th column is connected to a neighboring gate line Gₐ located directly below the (a)th pixel row.

In other words, a gate line of a given row is alternately connected to TFTs Q of pixel electrodes located directly above and below the given row. For example, in a bth column of pixel electrodes, the (a+1)th gate line Gₐ₊₁ is connected to the TFT Q of the pixel electrode of the ath pixel row located directly above the (a+1)th gate line Gₐ₊₁. In the (b+1)th column of pixel electrodes, the (a+1)th gate line Gₐ₊₁ is connected to the TFT Q of the pixel electrode of an (a+1)th pixel row located directly below the (a+1)th gate line Gₐ₊₁. This structure is repeated over an array of the pixel electrodes in a matrix.

With the above-described structure, the number of gate lines 22 is greater than the number of columns of pixel electrodes by one. As understood from FIG. 2, the first gate line 22 is alternately connected to TFTs Q of pixel electrodes 80 located below the first gate line, and the last gate line 22 is alternately connected to TFTs Q of pixel electrodes located above the last gate line. Accordingly, the columns to which the pixel electrodes 80 connected to the first gate line 22 and the last gate line 22 belong are placed in alternate positions.

The TFTs Q connected to vertically neighboring pixel electrodes 80 belonging to a given column are connected to the source electrode 65 branched from a data line 62. In detail, data line 62 is connected to the TFTs Q of the pixel electrodes 80 adjacent to one-side of data line 62. For example, TFTs of the pixel electrodes 80 belonging to the (b+1)th column are connected to source electrodes branched from the (b+1)th data line 62. With the above-described configuration, the number of data lines is the same as the number of rows of the pixel electrodes.

In a case where a pixel electrode array is formed in an m×n matrix, the number of gate lines 22 is m+1, and the number of data lines 62 is n.

Pixels of a display respective corresponding device can represent various colors. For example, pixels of a display device represent red (R), green (G), and blue (B), and a variety of colors can be represented by adjusting the gray levels of the pixels. In order for a pixel to represent a predetermined color, a color filter corresponding to the predetermined color can be placed over a pixel electrode of the pixel, or a phosphor layer or a light-emitting layer can be formed on the pixel. For convenience of explanation, suppose that a predetermined color is represented by a pixel electrode. However, the present invention can also be applied to a display device comprising a color filter, a phosphor layer or a light-emitting layer.

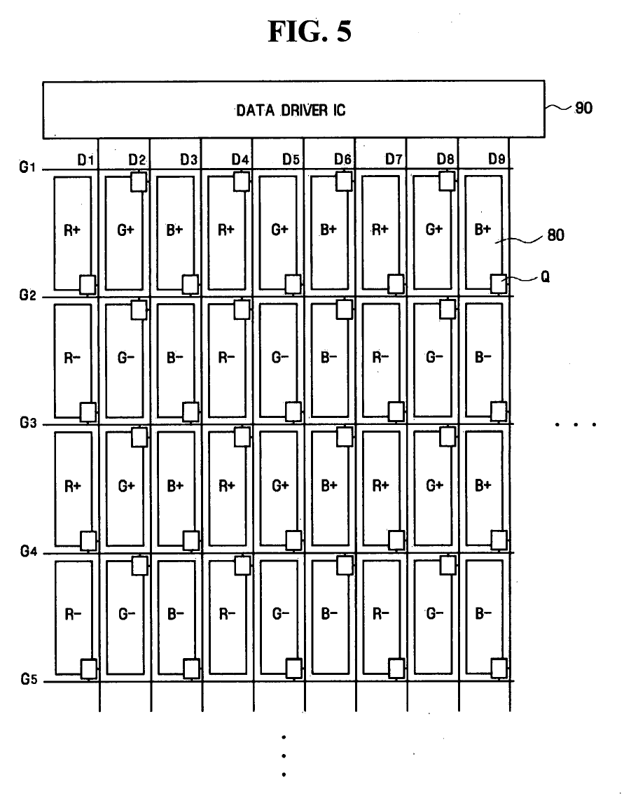

FIG. 5 is a schematic plan view of the display device shown in FIG. 2. In FIG. 5, TFTs are schematically represented in block form for simplicity.

Referring to FIG. 5, a plurality of pixel electrodes 80 are arranged on a display panel in such a manner that a pixel electrode 80 which represents R, a pixel electrode 80 which represents G, and a pixel electrode 80 which represents B alternate one another in a row-wise direction. Each of the pixel electrodes 80 forms a dot as a display unit. The dot may be a regular square. For this, the ratio of the row-wise length of each of the pixel electrodes 80 to the cross-wise length thereof may be about 1:3.

A data driver IC 90 is located at one side of the display panel. The data driver IC 90 is connected to the plurality of data lines D₁ through D₉ and applies a data signal including a data voltage. According to the current embodiment of the present invention, the polarity of the data voltage supplied from the data driver IC 90 is reversed at intervals of one horizontal period (1 H) corresponding to the time during which gate-on signals are applied to gate lines G₁ through G₅.

Alternatively, the polarity of the data voltages applied to neighboring data lines from the data driver IC 90 may be reversed in each data line

Therefore, even though data voltages applied to the data lines D₁-D₉ during the same time period are different from one another in terms of polarity, TFTs Q connected to horizontally neighboring pixel electrodes 80 belonging to a given row are connected to the gate lines G₁-G₅ belonging to different rows adjacent to the pixel electrodes 80, so that the data voltages applied to the pixel electrodes 80 of the corresponding row will eventually have the same polarity.

For example, TFTs Q connected to the first gate line G₁ are turned on when a gate-on signal is applied to the first gate line G₁. Then, even-numbered pixel electrodes 80 of the first row, i.e., the second, fourth, sixth, and eighth pixel electrodes in the first row, are charged with data voltages from even-numbered column data lines D₂, D₄, D₆, and D₈, respectively.

After a 1 H period elapses, a gate-off signal is applied to the first gate line G₁, and a gate-on signal is applied to the second gate line G₂. Accordingly, the TFTs Q of the second, fourth, sixth, and eighth pixel electrodes 80 of the first row are turned off, TFTs Q of odd-numbered pixel electrodes 80 of the first row, i.e., first, third, fifth, seventh, and ninth pixel electrodes 80 of the first row, are turned on, and TFTs Q of even-numbered pixel electrodes 80 of the second row, i.e., second, fourth, sixth, and eighth pixel electrodes 80 of the second row, are turned on. Then, the first, third, fifth, seventh, and ninth pixel electrodes 80 of the first row are charged with data voltages from the data lines D₁, D₃, D₅, D₇, and D₉ respectively, and the second, fourth, sixth, and eighth pixel electrodes 80 of the second row are charged with data voltages from the data lines D₂, D₄, D₆, and D₈, respectively. The data voltage applied to the second, fourth, sixth, and eighth pixel electrodes 80 of the second row during the second 1 H period has an opposite polarity of the data voltage applied to the second, fourth, sixth, and eighth pixel electrodes 80 of the first row during the first 1 H period, that is, a negative polarity, whereas the data voltage applied to the first, third, fifth, seventh, and ninth pixel electrodes 80 of the first row during the second 1 H period has a positive polarity. Therefore, as shown in FIG. 5, the pixel electrodes 80 of the first row are all charged with a positive-polarity data voltage. Likewise, the pixel electrodes 80 of the second row are all charged with a negative-polarity data voltage. This type of data voltage charging operation is directly applied to pixel electrodes 80 other than those in the first and second rows. Therefore, the pixel electrodes 80 can be driven by way of row inversion.

With the above-described structure, the display device according to the current embodiment of the present invention can realize row inversion driving even when the display device includes the data driver IC 90 which applies opposite-polarity data voltages to neighboring data lines D₁-D₉ and is controlled to reverse the polarity of the data voltages at 1 H intervals.

A display device according to a second embodiment of the present invention will now be described in detail, and structural elements of the display device in accordance with the second embodiment that correspond to or the same as those in the display device of the first embodiment will not be explained or be briefly explained.

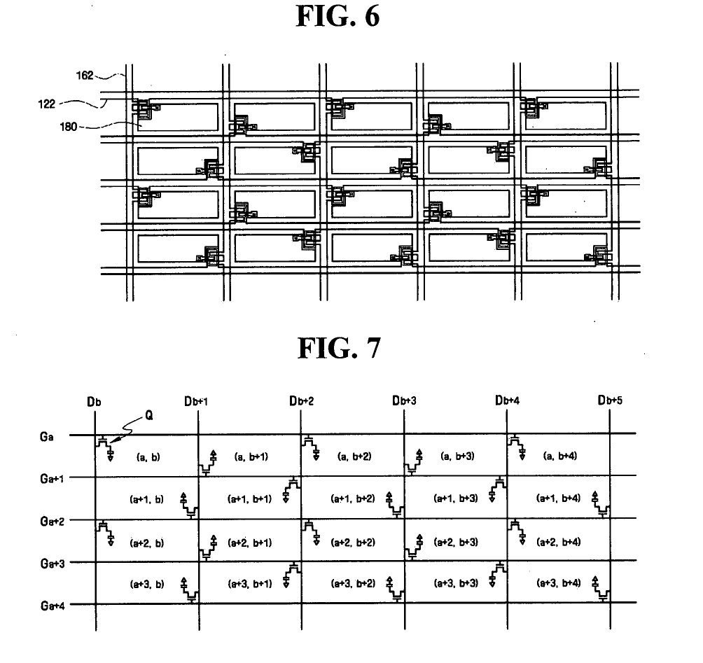

FIG. 6 is a layout view of a display device according to a second embodiment of the present invention, and FIG. 7 is a circuit diagram of the display device shown in FIG. 6.

Referring to FIGS. 6 and 7, a plurality of pixel electrodes 180 are insulated from one another and are arranged in a matrix. Each of a plurality of pixels of the display device is defined by neighboring gate lines 122 and neighboring data lines 162. The pixel electrodes 180 almost completely cover the respective corresponding pixel regions. The plurality of pixels have substantially the same construction with one another are arranged in positions which are symmetrical to a specified line or point (line symmetry or point symmetry). The construction of each pixel of the display device is the same as the construction of each pixel of the display device according to the first embodiment of the present invention.

In the second embodiment of the present invention TFTs Q connected to neighboring pixel electrodes 180 belonging to a given column are connected to gate electrodes protruding from neighboring gate lines 122 belonging to different rows. The number of gate lines 122 is greater than the number of rows of pixel electrodes 180 by 1.

TFTs Q of neighboring pixel electrodes 180 belonging to a given column are connected to source electrodes branched from adjacent data lines 162. For example, a TFT Q of a pixel electrode 180 located at an area defined by an (a+1)th pixel row and a (b+1)th column is connected to the right-side data line D_{b+2}, and a TFT Q of a pixel electrode 180 located at an area defined by an (a+2)th pixel row and the (b+1)th column is connected to the left-side data line D_{b+1}.

In other words, each data line is alternately connected to TFTs Q of pixel electrodes 180 disposed at left and right sides for each row. For example, in an ath pixel row, the (b+1)th data line D_{b+1} is connected to the TFT Q of the pixel electrode 180 of the right-side (b+1)th column. In the (a+1)th pixel row, the bth data line D_{b+1} is connected to the TFT Q of the pixel electrode 180 of the left-side bth column. This connection structure is repeated over the entire pixel electrode array.

With the above-described structure, the number of data lines is greater than the number of rows by 1. Referring to FIGS. 6 and 7, the first data line 162 is alternately connected to TFTs Q of every other right-side pixel electrodes 180 and the last data line 162 is connected to TFTs Q of every other left-side pixel electrodes 180. The rows to which the pixel electrodes 180 connected to the first data line 162 and the last data line 162 belong are placed in alternate.

As described above, in a case where a pixel electrode array is formed in an m×n matrix, the number of gate lines 122 is m+1, and the number of data lines 162 is n+1.

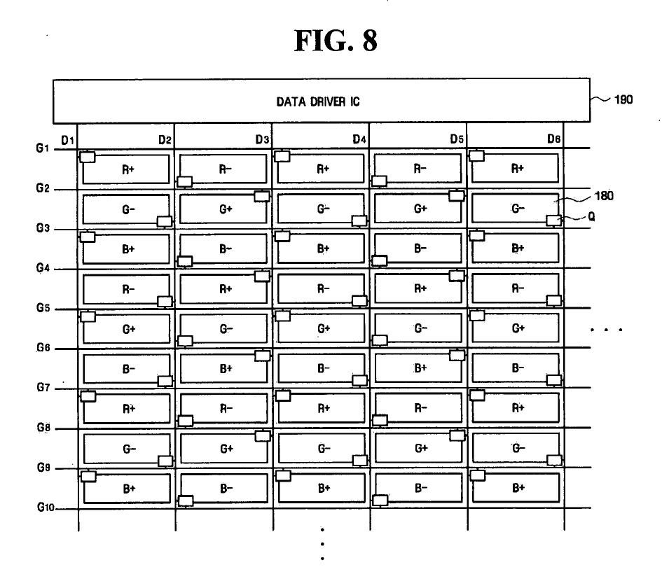

FIG. 8 is a schematic plan view of the display device shown in FIG. 6. In FIG. 8, TFTs are schematically represented in block form for simplicity. Also, R, G and B represented on the respective pixels indicate red, green and blue pixel electrodes, respectively.

Referring to FIG. 8, a plurality of pixel electrodes 180 are arranged on a display panel in such a manner that a pixel electrode 180 which represents R, a pixel electrode 180 which represents G, and a pixel electrode 180 which represents B alternate one another in a column-wise direction. Each of the pixel electrodes 180 forms a dot as a display unit. The dot may be a regular square. For this, the pixel electrodes 180 extend longer in the transverse direction than in a vertical direction. For example, the ratio of the row-wise length of each of the pixel electrodes 180 to the column-wise length thereof may be about 3:1.

A data driver IC 190 is located at one side of the display panel. The data driver IC 190 is connected to a plurality of data lines D₁ through D₆ and applies a data signal including a data voltage. The number of data lines according to the second embodiment of the present invention is smaller than the number of data lines of the display device according to the first embodiment of the present invention. For example, according to the first embodiment of the present invention, 768 gate lines and 1280×3 data lines are needed to realize a total of 1280×768 dots. On the other hand, according to the second embodiment of the present invention, 768×3 gate lines and 1280 data lines are needed to realize as many dots. Therefore, the number of data lines of the display device according to the second embodiment of the present invention is reduced to one third of the number of data lines of the display device according to the first embodiment of the present invention, thus reducing the number of data driver ICs 190 needed to drive data lines. Even though the number of gate lines of the display device according to the second embodiment of the present invention is three times greater than the number of gate lines of the display device according to the first embodiment of the present invention, additional manufacturing costs can be minimized by forming a gate driving circuit on a display panel.

According to the second embodiment of the present invention, a data voltage applied to each of the data lines D₁ through D₆ by the data driver IC 190 for each of a plurality of frames has the same polarity all the time regardless of a horizontal period (1 H) during which the data voltage is applied to the corresponding data line. Meanwhile, the polarity of a data voltage applied to a data line for a current frame is opposite to the polarity of a data voltage applied to the data line for a previous frame. In addition, data voltages applied to neighboring data lines from the data driver IC 190 are opposite to each other in polarity.

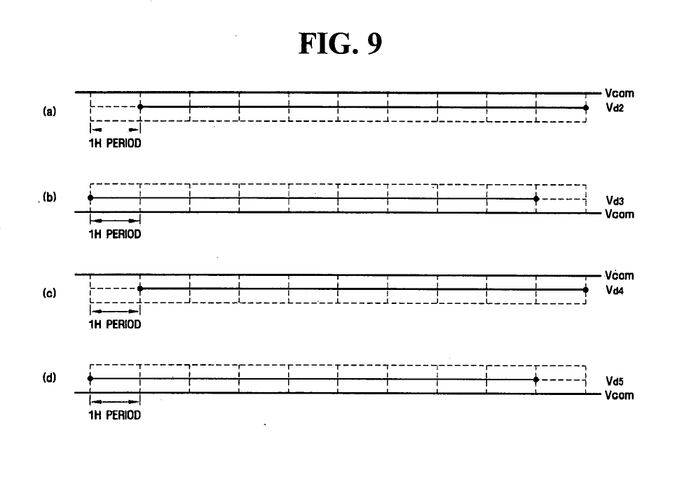

FIG. 9 is a waveform diagram of Vd₂, Vd₃, Vd₄, and Vd₅ applied to data lines D₂, D₃, D₄, and D₅ shown in FIG. 8.

Referring to FIGS. 8 and 9, when a gate-on signal is applied to the first gate line G₁, and thus the TFT Q connected thereto is turned on, odd-numbered pixel electrodes 180 of the first row are charged with a data voltage from the first, third, and fifth data lines D₁, D₃, and D₅. Suppose that the data voltage applied to the first, third, and fifth data lines D₁, D₃, and D₅ is a positive-polarity data voltage and the data voltage applied to the second, fourth, and sixth data lines D₂, D₄, and D₆ is a negative-polarity data voltage. The data voltage with which the odd-numbered pixel electrodes 180 of the first row are charged is a positive-polarity data voltage.

Then, after a time of a 1 H period elapses, a gate-off signal is applied to the first gate line G₁, and a gate-on signal is applied to the second gate line G₂. Accordingly, the TFTs Q of the odd-numbered pixel electrodes 180 of the first row are turned off, and TFTs Q of even-numbered pixel electrodes 180 of the first row and TFTs Q of even-numbered pixel electrodes 180 of the second row are all turned on. Then the even-numbered pixel electrodes 180 of the first row are charged with negative-polarity data voltages from the data lines D₂, D₄, and D₆, and the even-numbered pixel electrodes 180 of the second row are charged with positive-polarity data voltages from the data lines D₁, D₃, and D₅.

After a 1 H period elapses to reach a third 1 H period, a gate-off signal is applied to the second gate line G₂, and a gate-on signal is applied to the third gate line G₃. Then the TFTs Q of the even-numbered pixel electrodes 180 of the first row and the TFTs Q of the even-numbered pixel electrodes 180 of the second row are all turned off, and TFTs Q of odd-numbered pixel electrodes 180 of the second pixel row and TFTs Q of odd-numbered pixel electrodes 180 of a third pixel row are turned on. Accordingly, the odd-numbered pixel electrodes 180 of the second pixel row are charged with positive-polarity data voltages from the data lines D₁, D₃, and D₅, and the odd-numbered pixel electrodes 180 of the third pixel row are charged with negative-polarity data voltages from the data lines D₂, D₄, and D₆.

The aforementioned operation is performed at intervals of 1 H period. All the pixel electrodes 180 of the display panel are charged with a data voltage during a time period corresponding to one frame, a sub-dot inversion driving operation is performed so that the polarities of voltages with which neighboring pixel electrodes 180 are respectively charged differ from each other.

When data voltages applied to a pair of data lines increase or decrease, variations of the data voltages accumulate, thus affecting the common voltage, i.e., the coupling phenomenon occurs. The coupling phenomenon may result in a horizontal crosstalk. According to the second embodiment of the present invention, a data voltage applied to each of the data lines D₁ through D₆ is altered according to a gray level applied to the corresponding data line. When the same gray level is applied to the data lines D₁ through D₆, the waveforms shown in FIG. 9 are obtained. Referring to FIG. 9, the data voltages applied to the data lines D₂, D₃, D₄, and Ds, which are adjacent to one another, do not change and thus do not cause the coupling phenomenon. Therefore, according to the second embodiment of the present invention, it is possible to prevent a horizontal crosstalk from occurring.

Various display patterns which can be implemented by a display device according to the second embodiment of the present invention and variations of data voltages applied to a plurality of data lines of the display device will now be described in detail for determining whether the display device generates a horizontal crosstalk.

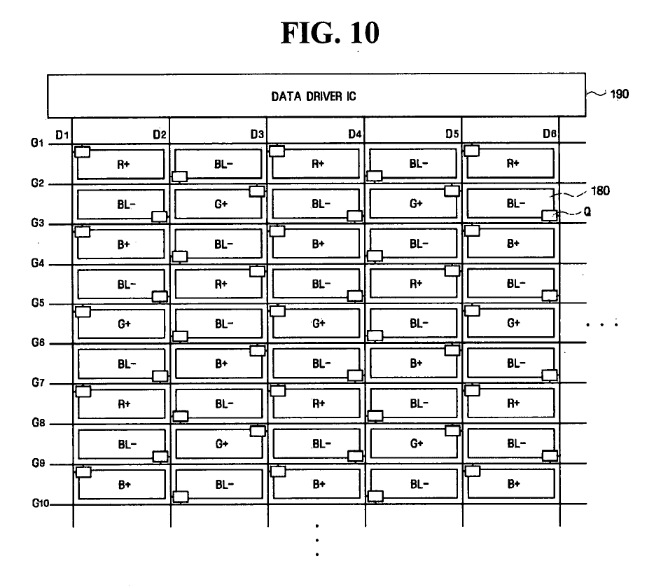

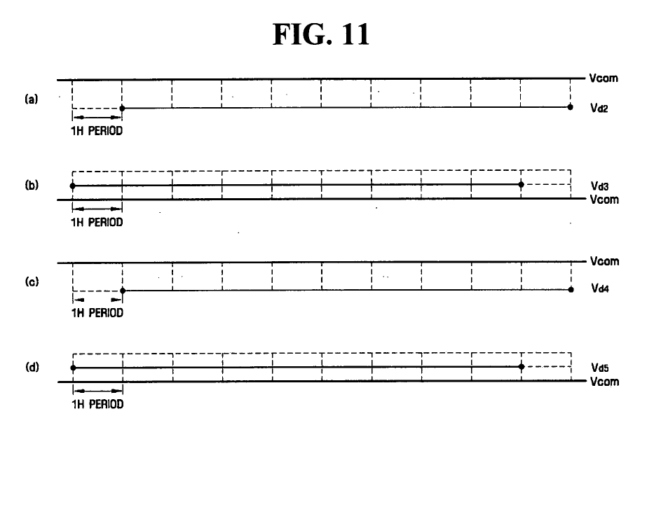

FIG. 10 is a schematic plan view of the display device shown in FIG. 6, in which a first display pattern is implemented by the display device according to the second embodiment of the present invention, and FIG. 11 is a waveform diagram of Vd₂, Vd₃, Vd₄, and Vd₅ applied to data lines D₂, D₃, D₄, and D₅ shown in FIG. 10. The display device shown in FIG. 10 is substantially the same as the display device shown in FIG. 8 except that it implements a different display pattern from the display device shown in FIG. 8. Therefore, the polarities of data voltages with which a plurality of pixel electrodes 180 shown in FIG. 10 are respectively charged are the same as the polarities of data voltages with which the respective pixel electrodes 180 shown in FIG. 8 are charged. Referring to FIG. 10, reference character ‘BL’ indicates black, and it is assumed that a highest data voltage is applied to pixel electrodes 180 represented by ‘BL’. In addition, R, G, and B are colors which can be represented by a pixel electrode 180 and are thus assumed to have the same gray level.

Referring to the first display pattern of FIG. 10, even-numbered pixel electrodes 180 of each odd-numbered column are represented by BL, and odd-numbered pixel electrodes 180 of each even-numbered column are represented by BL. In other words, the first display pattern is implemented by interposing BL among R, G, and B.

In detail, a negative-polarity data voltage is applied to a second data line D₂. The second data line D₂ applies a data voltage V_{d2} corresponding to BL to a plurality of pixel electrodes 180 connected to the second data line D₂. A waveform of the data voltage V_{d2} is shown in FIG. 11(a).

A positive-polarity data voltage is applied to a third data line D₃. The third data line D₃ applies a data voltage V_{d3} corresponding to R, G, or B to a plurality of pixel electrodes 180 connected to the third data line D₃. A waveform of the data voltage Vd₃ is shown in FIG. 11(b). A waveform of a data voltage V_{d4} applied to a fourth data line D₄ to implement the first display pattern is shown in FIG. 11(c), and a waveform of a data voltage V_{d5} applied to a fifth data line Ds to implement the first display pattern is shown in FIG. 11(d).

Referring to FIG. 11, the data voltage V_{d2} applied to the second data line D₂ and the data voltage V_{d3} applied to the third data lines D₃ have different polarities but both do not change. Likewise, the data voltage V_{d4} applied to the fourth data line D₄ and the data voltage V_{d5} applied to the fifth data line D₅ have different polarities but both do not change. Therefore, the display device according to the second embodiment of the present invention does not cause the coupling phenomenon and does not generate a horizontal crosstalk when implementing the first display pattern.

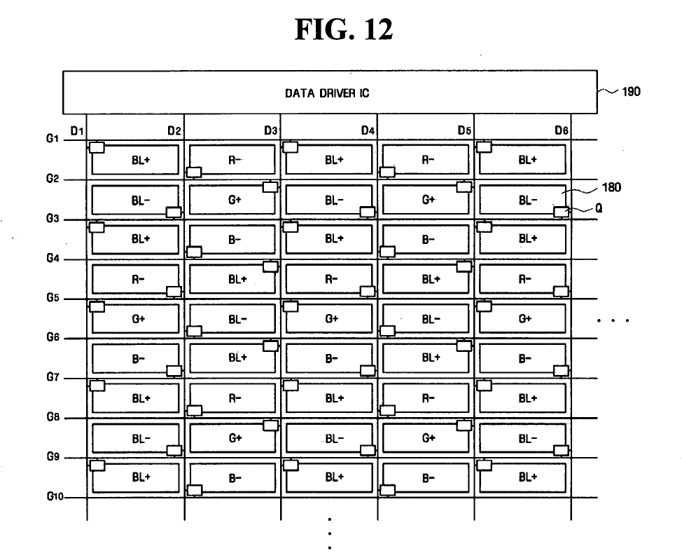

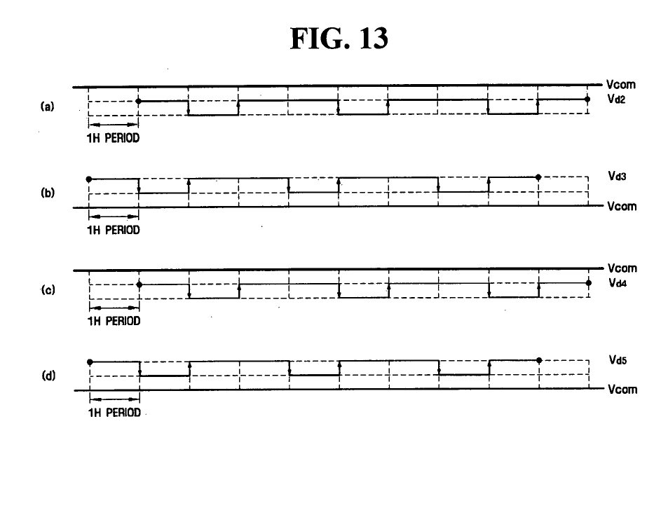

FIG. 12 is a schematic plan view of the display device shown in FIG. 6, in which a second display pattern is implemented by the display device according to the second embodiment of the present invention, and FIG. 13 is a waveform diagram of data voltages applied to data lines shown in FIG. 12.

The display device shown in FIG. 12 is substantially the same as the display device shown in FIG. 8 except that it implements a different display pattern from the display device shown in FIG. 8. Therefore, the polarities of data voltages with which a plurality of pixel electrodes 180 shown in FIG. 12 are respectively charged are the same as the polarities of data voltages with which the respective pixel electrodes 180 shown in FIG. 8 are charged. Referring to FIG. 12, reference character ‘BL’ indicates black, and it is assumed that a highest data voltage is applied to pixel electrodes 180 represented by ‘BL’. In addition, reference characters R, G and B indicate colors which can be represented by a pixel electrode 180 on the assumption that they have the same gray level.

Referring to a second display pattern shown in FIG. 12, even-numbered dots for each of a plurality of odd-numbered columns are represented by BL, and odd-numbered dots for each of a plurality of even-numbered columns are represented by BL. As described above, three pixel electrodes 180 form a dot.

For example, a negative-polarity data voltage is applied to the second data line D₂. Then the second data line D₂ provides a data voltage V_{d2} which keeps fluctuating to sequentially represent BL, G, BL, BL, G, BL, BL, G, and BL. A waveform of the data voltage V_{d2} is shown in FIG. 13(a).

A positive-polarity data voltage is applied to the third data line D₃. Then the third data line D₃ provides a data voltage V_{d3} which keeps fluctuating to sequentially represent R, BL, B, R, BL, B, R, BL, and B. A waveform of the data voltage V_{d3} is shown in FIG. 13(b). A waveform of a data voltage V_{d4} applied to the fourth data line D₄ to implement the second display pattern is shown in FIG. 13(c), and a waveform of a data voltage V_{d5} applied to the fifth data line D₅ to implement the second display pattern is shown in FIG. 13(d).

Referring to FIGS. 13(a) and 13(b), after a first 1 H period elapses, the data voltage V_{d3} applied to the third data line D₃ drops, and the data voltage V_{d2} is applied to the second data line D₂ for the first time. Accordingly, the data voltage V_{d2} and the data voltage V_{d3} do not change in the same direction. Therefore, variations of the data voltage V_{d2} and the data voltage V_{d3} are not accumulated, so that the coupling effect is not aggravated.

After a second 1 H period elapses, the data voltage V_{d2} applied to the second data line D₂ drops, but the data voltage V_{d3} applied to the third data line D₃ inclines. Therefore, the data voltage V_{d2} and the data voltage V_{d3} change in opposite directions and thus offset each other. Thus, it is possible to minimize the coupling effect.

After a third 1 H period elapses, the data voltage V_{d2} applied to the second data line D₂ changes, but the data voltage V_{d3} applied to the third data line D₃ does not change. Therefore, it is possible to mitigate the coupling phenomenon.

Likewise, after a fourth, sixth, seventh, or ninth 1 H period elapses, either the data voltage V_{d2} or the data voltage V_{d3} changes, and thus, it is possible to prevent the coupling phenomenon from being severe. In addition, after a fifth or seventh 1 H period elapses, the data voltage V_{d2} and the data voltage V_{d3} change in opposite directions and thus offset each other. Thus, it is possible to minimize the coupling effect.

The waveform of the data voltage V_{d4} shown in FIG. 13(c) is the same as the waveform of the data voltage V_{d2} shown in FIG. 13(a), and thus, the relationship between the third data line D₃ and the fourth data line D₄ is the same as the relationship between the second data line D₂ and the third data line D₃. Also, it can be seen from FIG. 11(d) that the relationship between the fourth data line D₄ and the fifth data line D₅ is the same as the relationship between the second data line D₂ and the third data line D₃.

In short, when implementing the second display pattern, a display device according to the second embodiment of the present invention does not aggravate but alleviates the coupling phenomenon, thereby suppressing a horizontal crosstalk.

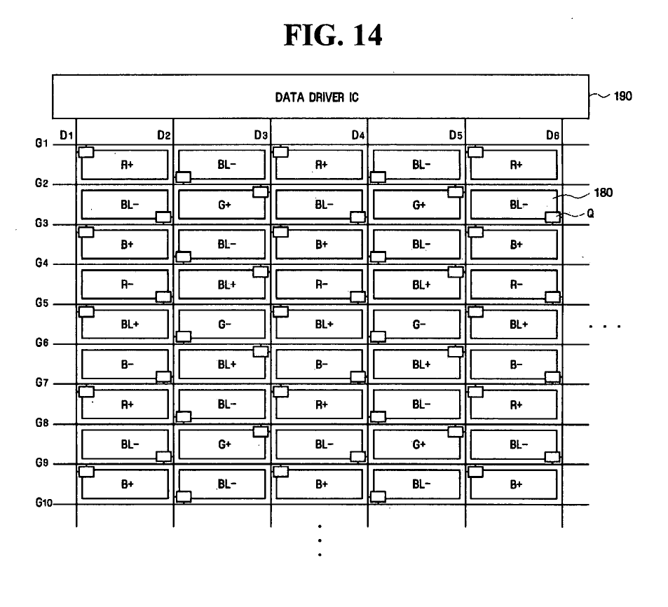

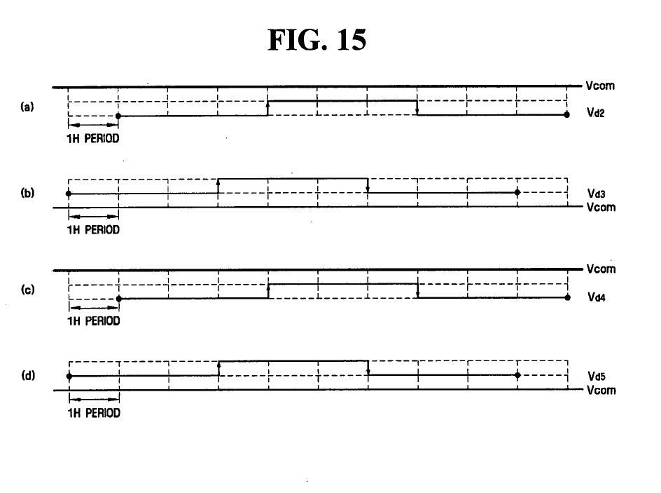

FIG. 14 is a schematic plan view of the display device shown in FIG. 6, in which a third display pattern is implemented by the display device according to the second embodiment of the present invention, and FIG. 15 is a waveform diagram of data voltages applied to data lines shown in FIG. 14. Therefore, the polarities of data voltages with which a plurality of pixel electrodes 180 shown in FIG. 14 are respectively charged are the same as the polarities of data voltages with which the respective pixel electrodes 180 shown in FIG. 8 are charged. Referring to FIG. 14, reference character ‘BL’ indicates black, and it is assumed that a highest data voltage is applied to pixel electrodes 180 represented by ‘BL’. In addition, R, G, and B are colors which can be represented by a pixel electrode 180 and are thus assumed to have the same gray level.

Referring to a third display pattern shown in FIG. 14, R, BL, and B patterns, instead of R, G, and B patterns, alternate one another in each of the odd-numbered columns, and BL, G, and BL patterns, instead of R, G, and B patterns, alternate one another in each of the even-numbered columns.

For example, a negative-polarity data voltage is applied to the second data line D₂. Then the second data line D₂ provides a data voltage V_{d2} which keeps fluctuating to sequentially represent BL, BL, BL, R, G, B, BL, BL, and BL. A waveform of the data voltage V_{d2} is shown in FIG. 15(a).

In addition, a positive-polarity data voltage is applied to the third data line D₃. Then the third data line D₃ provides a data voltage V_{d3} which keeps fluctuating to sequentially represent R, G, B, BL, BL, BL, R, G, and B. A waveform of the data voltage V_{d3} is shown in FIG. 15(b). A waveform of a data voltage V_{d4} applied to the fourth data line D₄ to implement the third display pattern is shown in FIG. 15(c), and a waveform of a data voltage V_{d5} applied to the fifth data line D₅ to implement the third display pattern is shown in FIG. 15(d).

Referring to FIG. 15(a) through 15(d), after a third, fourth, sixth, or seventh 1 H period elapses, only one of data voltages applied to neighboring data lines changes. Therefore, a display device according to the second embodiment of the present invention does not aggravate the coupling effect and does not generate a horizontal crosstalk when implementing the third display pattern.

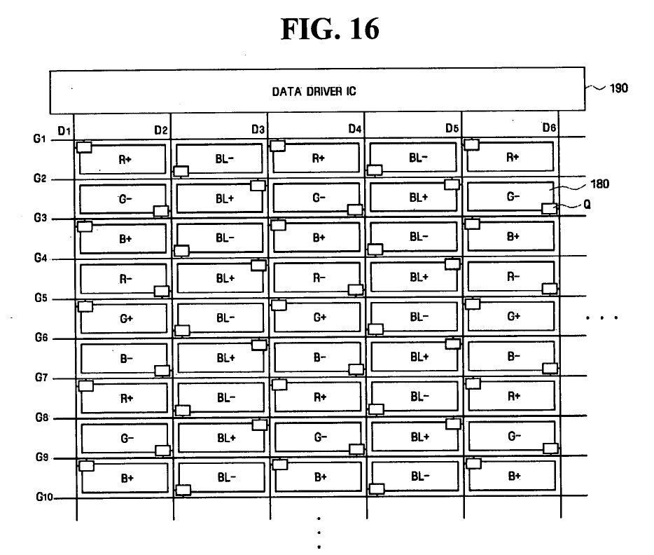

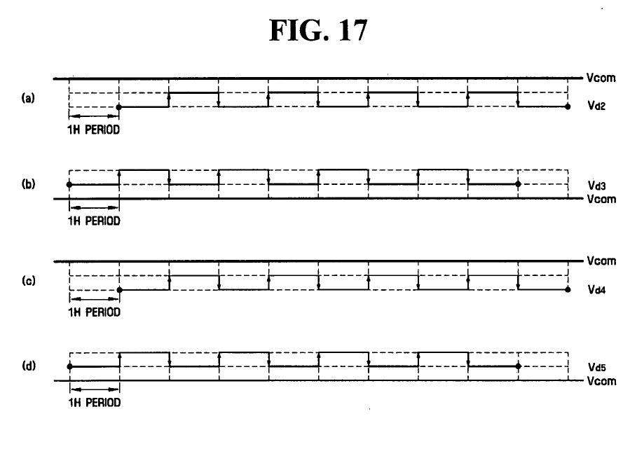

FIG. 16 is a schematic plan view of the display device shown in FIG. 6, in which a fourth display pattern is implemented by the display device according to the second embodiment of the present invention, and FIG. 17 is a waveform diagram of data voltages applied to data lines shown in FIG. 16.

The display device shown in FIG. 16 is substantially the same as the display device shown in FIG. 8 except that it implements a different display pattern from the display device shown in FIG. 8. Therefore, the polarities of data voltages with which a plurality of pixel electrodes 180 shown in FIG. 16 are respectively charged are the same as the polarities of data voltages with which the respective pixel electrodes 180 shown in FIG. 8 are charged. Referring to FIG. 16, reference character ‘BL’ indicates black, and it is assumed that a highest data voltage is applied to pixel electrodes 180 represented by ‘BL’. In addition, R, G, and B are colors which can be represented by a pixel electrode 180 and are thus assumed to have the same gray level.

Referring to a fourth display pattern shown in FIG. 16, R, G, and B patterns alternate one another in each of the odd-numbered columns, and a plurality of pixel electrodes 180 of each even-numbered column all represent BL. In other words, the fourth display pattern is implemented by interposing a column of pixel electrodes 180 representing BL between a pair of columns in which R, G, and B alternate one another.

A negative-polarity data voltage is applied to the second data line D₂. Then the second data line D₂ provides a data voltage V_{d2} which keeps fluctuating to sequentially represent BL, G, BL, R, BL, B, BL, G, and BL. A waveform of the data voltage V_{d2} is shown in FIG. 17(a).

A positive-polarity data voltage is applied to the third data line D₃. Then the third data line D₃ provides a data voltage V_{d3} which keeps fluctuating to sequentially represent R, BL, B, BL, G, BL, R, BL, and B. A waveform of the data voltage V_{d3} is shown in FIG. 17(b). A waveform of a data voltage V_{d4} applied to the fourth data line D₄ to implement the fourth display pattern is shown in FIG. 17(c), and a waveform of a data voltage V_{d5} applied to the fifth data line D₅ to implement the fourth display pattern is shown in FIG. 17(d).

Referring to FIG. 17(a) through 17(d), after the first, ninth, or tenth 1 H period elapses, only one of data voltages applied to neighboring data lines changes. Thus, it is possible to prevent the coupling phenomenon from being aggravated. In addition, after a second, third, fourth, fifth, sixth, seventh, or eighth 1 H period elapses, data voltages applied to neighboring data lines change in opposite directions and thus offset each other. Thus, it is possible to minimize the coupling phenomenon. Therefore, a display device according to the second embodiment of the present invention alleviates the coupling phenomenon and thus suppresses a horizontal crosstalk when implementing the third display pattern.

In short, a display device according to the second exemplary embodiment of the present invention can suppress a horizontal crosstalk regardless of which display pattern is implemented by the display device.

A display device according to a third embodiment of the present invention will now be described in detail, and structural elements of the display device in accordance with the third embodiment that correspond to or are the same as those in the display device of the first/second embodiment ware not explained or are briefly explained.

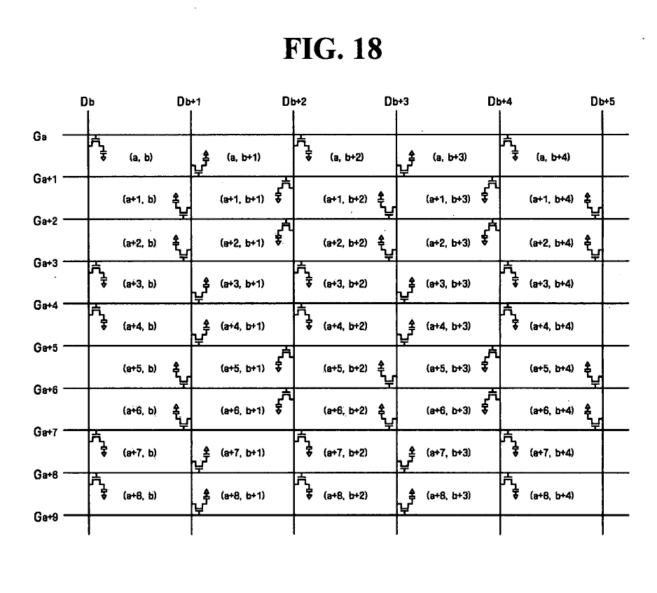

FIG. 18 is a circuit diagram of a display device according to a third embodiment of the present invention.

Referring to FIG. 18, the display device according to the third embodiment of the present invention is substantially the same as the display device according to the second embodiment of the present invention except for the followings. That is to say, unlike display device according to the second embodiment of the present invention in which TFTs of vertically neighboring pixel electrodes are connected to source electrodes branched from neighboring data lines, in the display device according to the third embodiment of the present invention, TFTs Q of vertically neighboring every 2 pixel electrodes 80 belonging to a given column are connected to the source electrodes 65 branched from data lines belonging to different columns adjacent to the pixel electrodes 80.

For example, referring to FIG. 18, a TFT of a pixel electrode located at an area defined by an (a+1)th pixel row and a (b+1)th column and a TFT of a pixel electrode located at an area defined by an (a+2)th pixel row and a (b+1)th column are both connected to the right-side data line D_{b+2}, and a TFT of a pixel electrode located at an area defined by an (a+3)th pixel row and a (b+1)th column and a TFT of a pixel electrode located at an area defined by an (a+4)th pixel row and the (b+1)th column are both connected to the left-side data line D_{b+1}.

According to the third embodiment of the present invention, TFTs of vertically neighboring pixel electrodes of first and second rows are connected to source electrodes branched from neighboring data lines. A TFT of an even-numbered pixel electrode and a TFT of an odd-numbered pixel electrode directly below the even-numbered pixel electrode constitute a basic unit and are connected to source electrodes branched from the same data line. Vertically neighboring basic units are connected to neighboring data lines. In an exemplary embodiment, as shown in FIG. 18, a TFT of a pixel electrode located at an area defined by an ath pixel row and the (b+1)th column is connected to the (b+1)th data line D_{b+1} located at the left side of the (b+1)th column of the pixel electrode, whereas the TFT of a pixel electrode located at an area defined by the (a+1)th pixel row and the (b+1)th column and the TFT of the pixel electrode located at an area defined by the (a+2)th pixel row and the (b+1)th column are both connected to the right-side data line D_{b+2}. Then vertically neighboring basic units are connected to neighboring data lines. Assuming that a=1, the display device shown in FIG. 18 satisfies the above description. Also, assuming that a=1 and b=1, the display device shown in FIG. 18 still satisfies the above description, but the present invention is not restricted thereto.

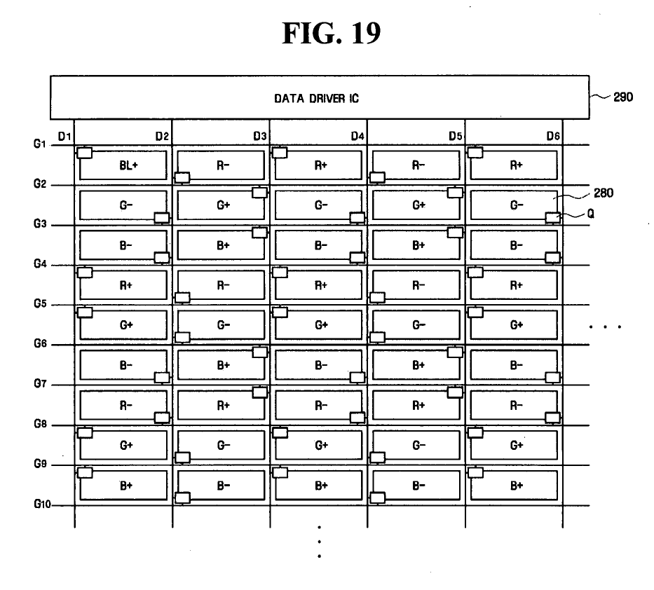

FIG. 19 is a plan view of the display device shown in FIG. 18. In FIG. 19, TFTs are schematically represented in block form for simplicity, and R, G and B represented on the respective pixels indicate red, green and blue pixel electrodes 280, respectively.

In the third embodiment of the present invention, like in the second embodiment shown in FIG. 8, the pixel electrodes 280 are arranged on a display panel in such a manner that a pixel electrode 280 representing R, a pixel electrode 280 representing G, and a pixel electrode 280 representing B alternate one another in a column-wise direction. The pixel electrodes 280 extend longer in a transverse direction than in a vertical direction. For example, the ratio of the row-wise length of the pixel electrodes 280 to the column-wise length of the pixel electrodes 280 may be about 3:1.

A data driver IC 290 is located at one side of the display panel. The data driver IC 290 is connected to a plurality of data lines D₁ through D₆ and applies a data signal including a data voltage. A gate driving unit (not shown) may include a gate driving circuit which is formed on the display panel.

According to the third embodiment of the present invention, data voltages applied from the data driver IC 290 have the same polarity for each of a plurality of frames regardless of regardless of a 1 H period during which the data voltage is applied to the corresponding data line. Accordingly, in order to drive the display panel in a frame inversion manner, the polarity of a data voltage applied to a data line for a current frame is opposite to the polarity of a data voltage applied to the data line for a subsequent frame. In addition, data voltages applied to neighboring data lines by the data driver IC 290 have opposite polarities. The polarities of data voltages with which the pixel electrodes 280 are respectively charged are shown in FIG. 19.

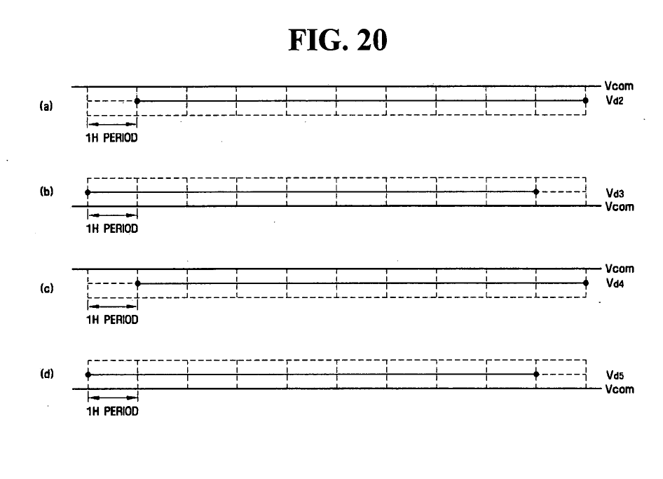

FIG. 20 is a waveform diagram of data voltages Vd₂, Vd₃, Vd₄, and Vd₅ applied to the data lines D₂ through Ds, respectively, shown in FIG. 19.

In the first and second periods of 1 H, the waveforms of the data voltages D₂ through Ds shown in FIG. 19 are the same as the waveforms of the data voltages D₂ through Ds shown in FIG. 9. In a third 1 H period, a gate-off signal is applied to a second gate line G₂, and a gate-on signal is applied to a third gate line G₃. Then TFTs Q of a plurality of even-numbered pixel electrodes 280 of the first row and TFTs Q of a plurality of even-numbered pixel electrodes 280 of the second row are turned off, and TFTs Q of a plurality of odd-numbered pixel electrodes 280 of the second row and TFTs Q of a plurality of even-numbered pixel electrodes 280 of a third row are turned on. Accordingly, the odd-numbered pixel electrodes 280 of the second row are charged with negative-polarity data voltages from the second, fourth, and sixth data lines D₂, D₄, and D₆, and the even-numbered pixel electrodes 280 of the third row are charged with positive-polarity data voltages from the first, third, and fifth data lines D₁, D₃, and Ds.

During a fourth horizontal period, a gate-off signal is applied to the third gate line G₃, and a gate-on signal is applied to a fourth gate line G₄. Then the TFTs Q of the odd-numbered pixel electrodes 280 of the second row and the TFTs Q of the even-numbered pixel electrodes 280 of the third row are turned off, and TFTs Q of a plurality of odd-numbered pixel electrodes 280 of the third row and TFTs Q of a plurality of odd-numbered pixel electrodes 280 of a fourth pixel row are turned on. Accordingly, the odd-numbered pixel electrodes 280 of the third row are charged with negative-polarity data voltages from the second, fourth, and sixth data lines D₂, D₄, and D₆, and the even-numbered pixel electrodes 280 of the fourth pixel row are charged with positive-polarity data voltages from the first, third, and fifth data lines D₁, D₃, and Ds.

During a fifth horizontal period, a gate-off signal is applied to the fourth gate line G₄, and a gate-on signal is applied to a fifth gate line G₅. Then the TFTs Q of the odd-numbered pixel electrodes 280 of the third row and the TFTs Q of the odd-numbered pixel electrodes 280 of the fourth pixel electrode are turned off, and TFTs Q of a plurality of even-numbered pixel electrodes 280 of the fourth pixel row and TFTs Q of a plurality of odd-numbered pixel electrodes 280 of a fifth pixel row are turned on. Accordingly, the even-numbered pixel electrodes 280 of the fourth pixel row are charged with negative-polarity data voltages from the second, fourth, and sixth data lines D₂, D₄, and D₆, and the odd-numbered pixel electrodes 280 of the fifth pixel row are charged with positive-polarity data voltages from the first, third, and fifth data lines D₁, D₃, and D₅.

When the aforementioned charging of the pixel electrodes 280 during a time period corresponding to one frame is terminated, the data voltage polarity pattern shown in FIG. 19 is obtained.

Referring to FIG. 20, assuming that R, G, and B have the same gray level, data voltages applied to neighboring data lines do not change in the same direction, thus suppressing the coupling phenomenon which occurs due to the accumulation of variations of data voltages. Therefore, it is possible to prevent a horizontal crosstalk from occurring. It will now be described whether a display device according to the third embodiment of the present invention generates a horizontal crosstalk when implementing various display patterns.

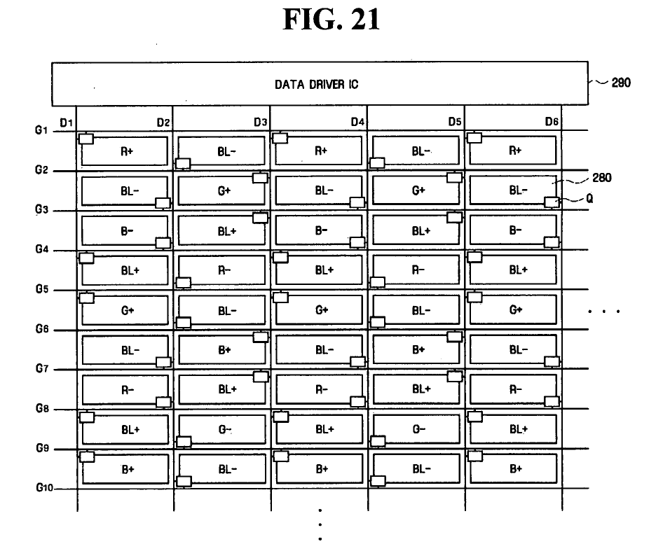

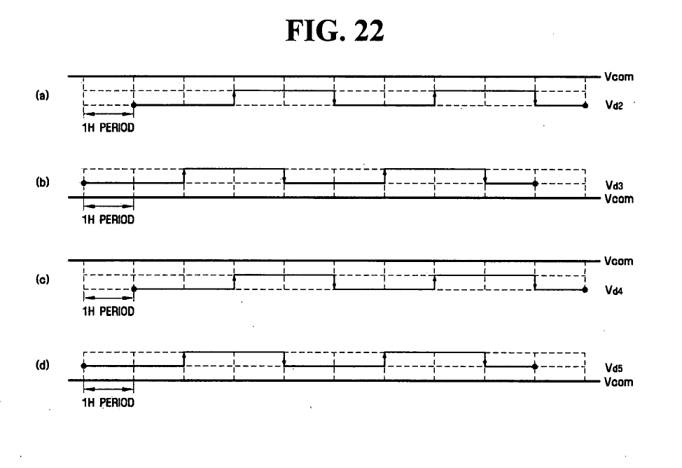

FIG. 21 is a plan view of the display device shown in FIG. 18, in which a first display pattern is implemented by the display device according to the third embodiment of the present invention, and FIG. 22 is a waveform diagram of data voltages Vd₂, Vd₃, Vd₄, and Vd₅ applied to data lines D₂, D₃, D₄, and D₅, respectively, shown in FIG. 21. The structure of the display device shown in FIG. 21 is substantially the same as the structure of the display device shown in FIG. 19, and the first display pattern shown in FIG. 21 is substantially the same as the first display pattern shown in FIG. 10.

Referring to FIGS. 21 and 22, after a second, third, fourth, fifth, sixth, seventh, or eighth 1 H period, one of data voltages applied to neighboring data lines changes. Therefore, a display device according to the third embodiment of the present invention does not aggravate the coupling phenomenon and does not generate a horizontal crosstalk when implementing the first display pattern.

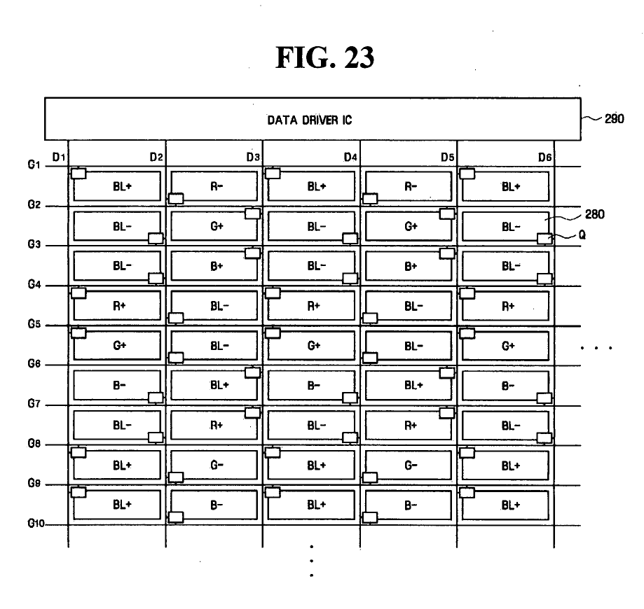

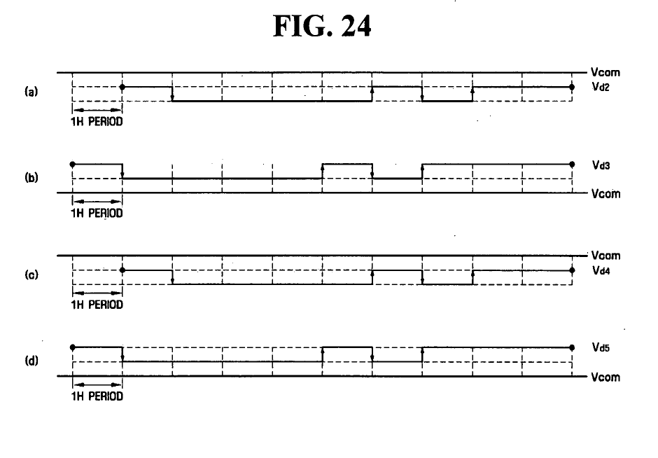

FIG. 23 is a plan view of the display device shown in FIG. 18, in which a second display pattern is implemented by the display device according to the third embodiment of the present invention, and FIG. 24 is a waveform diagram of data voltages applied to data lines shown in FIG. 23;

The structure of the display device shown in FIG. 23 is substantially the same as the structure of the display device shown in FIG. 19, and the second display pattern shown in FIG. 23 is substantially the same as the second display pattern shown in FIG. 12

Referring to FIGS. 23 and 24, after the first, second, fifth, or eighth 1 H period, one of data voltages applied to neighboring data lines changes, thus suppressing the coupling phenomenon from being aggravated. In addition, after a sixth or seventh 1 H period, data voltages applied to neighboring data lines change in opposite directions and thus offset each other, thus alleviating the coupling phenomenon. Therefore, a display device according to the third embodiment of the present invention alleviates the coupling effect when implementing a second display pattern, thus suppressing a horizontal crosstalk.

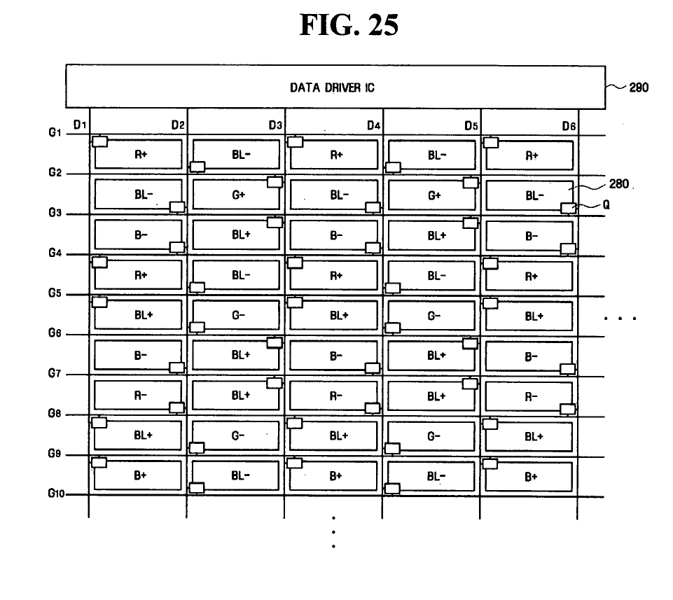

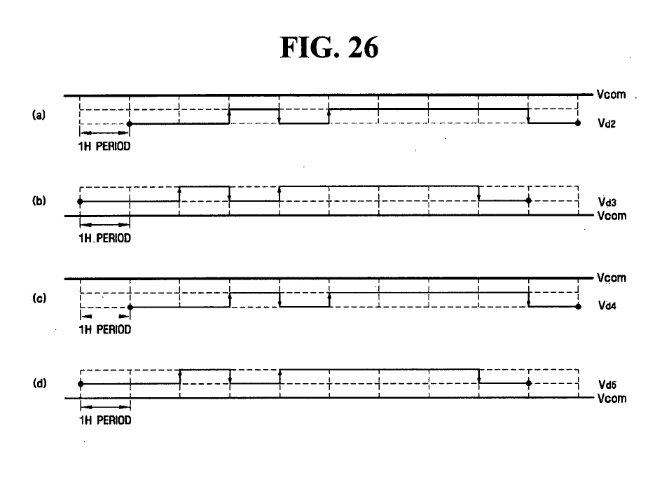

FIG. 25 is a plan view of the display device shown in FIG. 18, in which a third display pattern is implemented by the display device according to the third embodiment of the present invention, and FIG. 26 is a waveform diagram of data voltages applied to data lines shown in FIG. 25. The structure of the display device shown in FIG. 25 is substantially the same as the structure of the display device shown in FIG. 19, and the third display pattern shown in FIG. 25 is substantially the same as the third display pattern shown in FIG. 14.

Referring to FIGS. 25 and 26, after a second, fifth, eighth, or ninth 1 H period, one of data voltages applied to neighboring data lines changes, thus suppressing the coupling phenomenon. In addition, after a third or fourth 1 H period, data voltages applied to neighboring data lines change in opposite directions and thus offset each other, thus alleviating the coupling phenomenon. Therefore, a display device according to the third embodiment of the present invention alleviates the coupling phenomenon when implementing a third display pattern, thus suppressing a horizontal crosstalk.

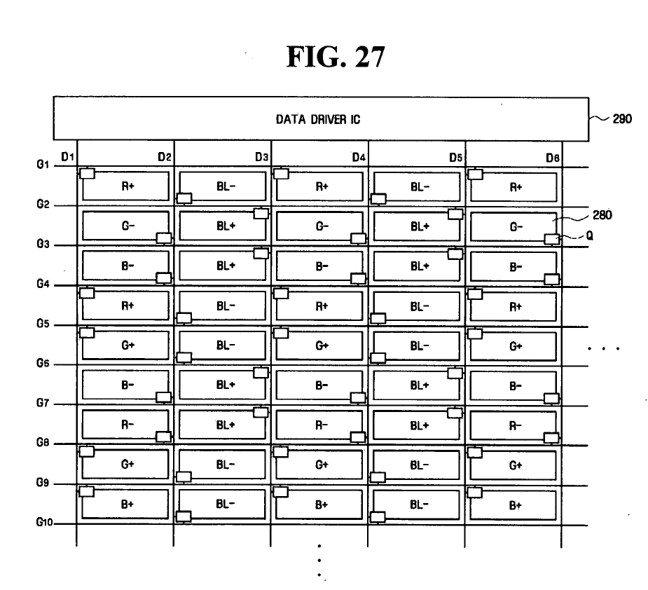

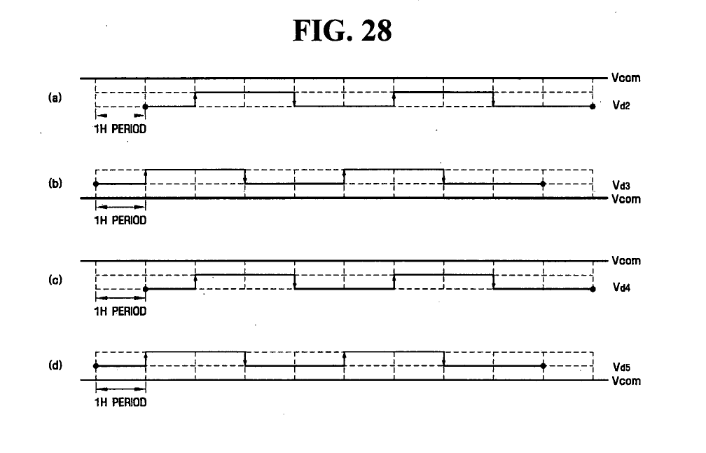

FIG. 27 is a plan view of the display device shown in FIG. 18, in which a fourth display pattern is implemented by the display device according to the third embodiment of the present invention; and FIG. 28 is a waveform diagram of data voltages applied to data lines shown in FIG. 27. The structure of the display device shown in FIG. 27 is substantially the same as the structure of the display device shown in FIG. 19, and the fourth display pattern shown in FIG. 27 is substantially the same as the fourth display pattern shown in FIG. 14.

Referring to FIGS. 27 and 28, after the first, second, third, fourth, fifth, sixth, seventh, or eighth 1 H period, one of data voltages applied to neighboring data lines changes. Therefore, a display device according to the third embodiment of the present invention does not aggravate the coupling effect and does not generate a horizontal crosstalk when implementing a fourth display pattern.

In short, a display device according to the third embodiment of the present invention can prevent a horizontal crosstalk when implementing a variety of display patterns.

As described above, the display device according to the present invention can prevent or alleviate a horizontal crosstalk when generating a variety of display patterns. Therefore, it is possible to enhance the image quality of the display device. In addition, it is possible to apply data voltages having various polarity patterns to the display panel of the display device even if the display device employs data driver ICs with a fixed polarity outputting method.

Although the present invention has been described in connection with the exemplary embodiments of the present invention, it will be apparent to those skilled in the art that various modifications and changes may be made without departing from the scope and spirit of the invention.

What is claimed is:

1. A display device comprising:
a matrix array of rows and columns of pixel electrodes and switching devices;
a plurality of gate lines extending in a row-wise direction between each of the rows of pixel electrodes; and
a plurality of data lines extending in a column-wise direction between each of the columns of pixel electrodes,
the switching devices of horizontally neighboring pixel electrodes belonging to a given row of the pixel electrode array are controlled by gate lines belonging to different rows.

2. The display device of claim 1, wherein the data lines are arranged at one side of the pixel electrode array in the column-wise direction of the pixel electrode array.

3. The display device of claim 2, wherein the pixel electrode array is an m×n matrix form, the number of gate lines is m+1, and the number of data lines is n.

4. The display device of claim 3, further comprising a data driving unit which alternately applies data voltages having different polarities to each of the data lines at a predetermined period of time during which a gate-on signal is applied such that the data voltages applied to neighboring data lines are opposite to each other in polarity.

5. The display device of claim 4, wherein data voltages having opposite polarities are applied to the pixel electrodes of neighboring rows.

6. The display device of claim 1, wherein the data lines are arranged at both sides of the pixel electrode array in the column-wise direction of the pixel electrode array.

7. The display device of claim 6, wherein the pixel electrode array is an m×n matrix, the number of gate lines is m+1, and the number of data lines is n+1.

8. The display device of claim 7, further comprising a data driving unit which applies data voltages having the same polarity to a data line during a time period corresponding to one frame and data voltages having a polarity opposite to that applied to the data line are applied to neighboring data lines of the data line.

9. The display device of claim 8, wherein switching devices of vertically neighboring pixel electrodes belonging to a given column among the plurality of columns are supplied with data voltages from data lines belonging to different columns.

10. The display device of claim 9, wherein the row-wise length of each of the pixel electrodes is longer than the column-wise length thereof.

11. The display device of claim 10, wherein the ratio of the row-wise length of each of the pixel electrodes to the column-wise length thereof is 3:1.

12. The display device of claim 10, further comprising a gate driving unit formed on the insulating substrate having the gate lines formed thereon and driving the gate line.

13. The display device of claim 7, wherein switching devices of every two vertically neighboring pixel electrodes belonging to a given column among the plurality of columns are supplied with data voltages from the data lines belonging to different columns that are adjacent to the two vertically neighboring pixel electrodes.

14. The display device of claim 13, wherein the row-wise length of each of the pixel electrodes is longer than the column-wise length thereof.

15. The display device of claim 14, wherein the ratio of the row-wise length of each of the pixel electrodes to the column-wise length thereof is 3:1.

16. The display device of claim 14, further comprising a gate driving unit formed on the insulating substrate having the gate lines formed thereon and driving the gate lines.

17. The display device of claim 7, wherein switching devices of vertically neighboring repeating units are supplied with data voltages from different data lines adjacent to the repeating units in a given column among the plurality of columns, each of the repeating units comprising a pair of switching devices of pixel electrodes belonging to an even-numbered row and an odd-numbered row directly next to the even-numbered row, wherein switching devices of pixel electrodes of the first row are supplied with data voltages for different data lines adjacent to the neighboring repeating units in a given column among the plurality of columns.

18. The display device of claim 17, wherein the row-wise length of each of the pixel electrodes is longer than the column-wise length thereof.

19. The display device of claim 18, wherein the ratio of the row-wise length of each of the pixel electrodes to the column-wise length thereof is 3:1.

20. The display device of claim 18, further comprising a gate driving unit formed on the insulating substrate having the gate lines formed thereon and driving the gate lines.
